(19) United States
(12) Patent Application Publication
(10) Pub. No.: US 2010/0015337 A1
(43) Pub. Date: Jan. 21, 2010

(54) METHOD FOR APPLYING INTERFERENCE PIGMENTS TO A SUBSTRATE

(75) Inventors: Franz Josef Becker, Bergisch Gladbach (DE); Viktor Uerlings, Duren (DE)

Correspondence Address: KNOBBE MARTENS OLSON & BEAR LLP, 2040 MAIN STREET, FOURTEENTH FLOOR, IRVINE, CA, 92614, US

(73) Assignee: M-REAL OYJ, Espoo (FI)

(21) Appl. No.: 12/297,201

(22) PCT Filed: Mar. 21, 2007
(86) PCT No.: PCT/EP2007/002483

§ 371 Date: Jun. 1, 2009

(30) Foreign Application Priority Data
Apr. 13, 2006 (EP) 06007801.1

(51) Int. Cl. B05D 5/00

(52) U.S. Cl. 427/258; 427/288

(57) ABSTRACT

The present invention relates to a method for applying interference pigments to a substrate, comprising the steps: a) provision of a substrate and b) application of a preparation to at least one side of the substrate, where the preparation contains at least one surfactant and at least one interference pigment, the interference pigment having a carrier material and at least one coat applied to the carrier material, and a substrate obtainable by the abovementioned method.

The present invention relates to a method for applying interference pigments to a substrate, and a substrate obtainable by the abovementioned method.

Even in the age of electronic data transmission, there is a general need for visually appealing papers. It is therefore an aim of the papermaking industry to produce papers which have appealing optical properties and also have a high paper quality. On the other hand, there is also a further need to protect substrates and in particular papers from forgeries by means of security features. One possibility of applying such security features consists in applying special printing inks comprising so-called security pigments to the substrate to be protected. However, a disadvantage here is that the amount which has to be applied is very high, so that such security features are associated with considerable costs.

In U.S. Pat. No. 4,534,157, a paper is color-printed in the moist state after it has been produced as a paper web, ink being applied by means of ink nozzles to an ink transfer roll which then transfers the ink onto the paper. An irregular, diffuse pattern is therefore applied with an amount of ink which remains constant over the entire paper web, the paper otherwise not being colored.

In EP-A-601 517, a white paper is printed with as little ink as possible in regular and irregular patterns. The ink penetrates into the paper only to a small extent. The application of the disclosure of EP-A-601 157 is in particular based on the slight penetration of the ink into the paper, since the paper can subsequently be recycled in the same way as a white paper. The ink should therefore be capable of being easily removed from the paper.

EP-A-681 060 discloses a method for the production of differently colored paper, cellulose fibers and agglomerates of different thickness being used in the papermaking process and being applied to the finished paper or incorporated there. The cellulose fibers or agglomerates having a different thickness are colored prior to application to or incorporation into the paper and are then introduced into the paper pulp which itself may have another color.

The methods which are currently used for the production of patterned papers are either complicated or the production process is slow or they lead to papers having a completely different effect.

EP-A-439 363 discloses a paper which contains desizing agents or is coated therewith, better absorption of the ink during the printing process being achieved as a result by an inkjet printing process. The desizing agent is distributed in this paper or has already been distributed on this paper uniformly over the entire paper surface in order to obtain an optimally printed copy.

EP-A-518 490 discloses an ink for inkjet printing, the ink containing a composition which facilitates the penetration of the ink into the printed paper.

Common to the teachings of EP-A-439 363 and EP-A-518 490 is that the penetration of polar liquids, such as, for example, inkjet inks, into the paper structure and into the paper fibers of the sized paper is facilitated by the use of suitable desizing agents. However, neither EP-A-439 363 nor EP-A-518 490 discloses the production of a patterned paper by means of nonuniform coloring of the paper surface with the use of interference pigments.

For improving the printing and inscribing properties of a base paper, EP-A-1 239 077 proposes applying a nonionic surfactant having a polyalkoxylene structure.

EP-A-732 219 discloses a print medium containing a liquid-absorbing base material, an ink acceptor layer which is applied to the base material and contains a pigment, a binder and a cationic substance, and a surface layer which is applied to the ink acceptor layer and is composed of cationic ultrafine particles as inorganic particles. Ultrafine particulate oxides of metals having a diameter in the range from 1 to 500 nm are described for this purpose. These particles form a closed, glossy surface layer. The pigments which are present in the ink acceptor layer are inorganic pigments having a diameter in the range from 0.1 to 20 μm.

A further possibility for producing nonuniformly colored papers is disclosed in the laid-open applications EP-A 1 439 263 and EP-A 1 281 812. Common to both documents is that a latent image or pattern is produced with the aid of a surfactant or surfactant mixture on a paper substrate, the paper thus treated being subsequently colored. In EP 1 439 263, pigments are present in the surfactant-containing preparation with which the latent image or pattern is produced. In this publication, however, it is not disclosed that interference pigments which consist of a carrier material and a coating applied thereon are present in the preparation.

It is an aim of the present invention to provide an optically appealing substrate where interference pigments are applied. Since the modification of a surface with interference pigments is very expensive, the amount of interference pigment which is used should be as small as possible.

A further aim of the present invention is to provide treated substrates which have security features, the security features being very difficult to forge or not being forgeable at all. It is therefore intended to provide a substrate as a security element in which safety features are introduced in a form which makes it impossible for a potential forger to counterfeit them.

The aim of the present invention is achieved by a method for applying interference pigments to a substrate, comprising the steps:
a) provision of a substrate and
b) application of a preparation to at least one side of the substrate, where the preparation contains at least one surfactant and at least one interference pigment, the interference pigment having a carrier material and at least one coat applied to the carrier material.

In the context of this invention, application of the preparation to the substrate is to be understood as meaning impregnation and/or coating. The substrate is coated and/or impregnated by application of the preparation.

In a preferred embodiment, the substrate in step a) is a paper and/or cardboard. Surface sizing of the substrate can be carried out instead of or in addition to engine sizing of the substrate. Here, film-forming substances, such as, for example, solutions or dispersions of modified starches, resins or modified polymers, are applied to the already formed paper web with the aid, for example, of a size press within a paper machine. The surface sizing also contributes to the strength of the paper, so that high-quality printing papers often have engine sizing and surface sizing. The presence of surface sizing is, however, not essential for the method of the present invention and moreover it is possible to use a substrate which has no surface sizing and/or engine sizing.

Alternatively, the method for the production of nonuniformly intensively colored substrate in step a) may comprise the application of a dye solution in the form of a visible image or pattern to the substrate.

Preferred embodiments of the invention are described in the subclaims.

Preferably, the preparation in step b) is applied in the form of a latent image or pattern.

The image or pattern may be present in the form of a representative image or of an imaginary structure, of a symbol, of a uniform or nonuniform pattern, of a network structure or of a nonuniform, e.g. random, distribution of color on the substrate.

The image or pattern can be applied either immediately after the papermaking, i.e. in the still moist paper, or on a subsequently produced dried paper, the paper then being uniformly colored by means of an aqueous dye solution. The image or pattern can be applied to a continuous paper web or to individual paper sheets. Preferably, the image or pattern is applied to a continuous paper web.

The image or pattern can be applied by any desired method, in particular by inkjet printing, offset printing, flexographic printing, gravure printing, printing with felt or rubber rolls, by spraying on or manually, the last method being unsuitable for industrial production. A particularly preferred application method for the image or pattern is application by means of an inkjet print, flexographic print or gravure print.

The pattern or image is applied either in the form of a latent image or pattern or in the form of an image or pattern visible on the paper.

The carrier material of the interference pigment in step b) preferably has a lamellar structure and/or is preferably an inorganic carrier material.

The concentration range of the at least one interference pigment in the preparation which is applied is 0.01 to 30 percent by weight, preferably 0.1 to 25 percent by weight, more preferably in the range from 0.2 to 15 percent by weight.

The carrier material of the interference pigment in step b) is furthermore preferably natural or synthetic mica, talc, kaolin, glass lamellae, SiO₂ lamellae, TiO₂ lamellae, Al₂O₃ lamellae, Fe₂O₃ lamellae, graphite lamellae or mixtures thereof.

Preferably, two, three, four, five, six, seven or eight coats, which preferably may each be identical or different, are applied to the carrier material of the interference pigment in step b). It is furthermore preferred if the refractive index of the respective coat is different from that of the coat applied beforehand. In a preferred embodiment, the difference in the refractive indices of two adjacent layers is in each case greater than 0.1.

Independently of one another, the coat/coats of the interference pigment in step b) preferably contains or contain oxides of metals or semimetals or mixtures thereof, such as, for example, silicon, tin, titanium, iron. It is furthermore preferred if the coat/coats of the interference pigment in step b) contains/contain oxides selected from TiO₂, titanium suboxide, titanium oxide nitride, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof.

Alternatively, it is also possible to use a semitransparent layer of a metal instead of the oxide coats, suitable metals preferably being selected from chromium, titanium, molybdenum, tungsten, aluminum, copper, silver, gold, nickel or mixtures thereof.

It is also possible for finely divided particles in the nanometer size range furthermore to be introduced into the respective coat, it having proved advantageous to introduce, for example, finely divided titanium dioxide or finely divided carbon (carbon black) having particle sizes in the range from 10 to 250 nm. Owing to the light-scattering properties of such particles, gloss and hiding power can furthermore be influenced in a more targeted manner.

Particularly preferred carrier materials are glass lamellae which are coated with titanium dioxide and/or Fe₂O₃, or glass lamellae which have at first one SiO₂ layer and are subsequently coated with TiO₂ and/or Fe₂O₃.

Also particularly preferred as interference pigments are multilayer pigments which in particular are based on mica and/or titanium dioxide. These preferably have as a rule alternating high-refraction and low-refraction layers which preferably contain the abovementioned metal oxides. More preferred multilayer pigments contain up to seven layers, preferably three, five or seven layers.

The interference pigments preferably have a thickness between 0.3 and 5 μm and in particular between 0.4 and 2.0 μm. The extension in the other two dimensions is usually between 1 and 250 μm, preferably between 2 and 100 μm and in particular between 5 and 60 μm.

In addition, even further substances are preferred as carrier material of the interference pigment, such as, for example, lamellar iron or alumina, graphite lamellae, BiOCl, lamellar holographic pigments or liquid crystal polymers (LCPs). The applied coat(s) may also contain metal oxides, hydrated metal oxide, MgF₂ or BiOCl.

If a plurality of coats are applied to the carrier material, it is preferable if the layer packet contains a layer of nonabsorbing material having a refractive index of n≦1.8 and a layer of nonabsorbing material having a refractive index of n≧1.8. It is preferable if the nonabsorbing material having a refractive index of n≦1.8 contains SiO₂, SiO(OH)₂, Al₂O₃, AlO(OH), P₂O₃, MgF₂ or mixtures thereof. It is furthermore preferable if the nonabsorbing material having a refractive index of n≦1.8 contains TiO₂, ZrO₂, ZnO, SnO₂, BiOCl or mixtures thereof. More preferably, a further coat which contains FeTiO₃ may be applied.

The coat(s) which are applied to the carrier material may also contain Al₂O₃, Ce₂O₃, P₂O₃, ZrO₂, SnO₂ or mixtures thereof. The abovementioned interference pigments can be prepared, for example, according to the methods of DE-A-102004032121, DE-A-10320455, DE-A-10061178, DE-A-19746067, DE-A-102004039554, DE-A-10051062 or DE-A-19817286.

It is preferable if the surfactant in step b) reduces the penetration of water-soluble dyes into the substrate. Moreover, it is preferable if the surfactant in step b) facilitates the penetration of water-soluble dyes into the substrate. Alternatively, it is also possible that both a surfactant which facilitates the penetration of water-soluble dyes into the paper and a surfactant which reduces the penetration of water-soluble dyes into the paper are applied in step b).

For the formation of a latent image or pattern, a substance which influences the penetration of aqueous dye solutions into the paper is applied to the paper, a substance being applied in order either to promote or to reduce the absorption.

This can be achieved by reduction (desizing agent) or increase (water repellent) by means of the applied substance, the degree of sizing or the degree of water repellency being achieved by the paper sizing.

Any substance which has these properties can be used for the method of the present invention. Surfactants are preferably used for this purpose. Anionic, cationic, nonionic or amphoteric surfactants can be used. In addition to the surfactants, it is possible to use further substances which facilitate the penetration of dyes into the paper. Such substances are, for example, glycol ethers, such as, for example, ethylene glycol monomethyl ether, ethylene glycol monoethyl ether, ethylene glycol monophenyl ether, diethylene glycol monomethyl ether, diethylene glycol monoethyl ether and diethylene glycol monobutyl ether.

Suitable desizing surfactants can be selected, for example, from (1) hydrophilic polydialkylsiloxanes, (2) polyalkylene glycol, (3) propylene oxide/polyethylene oxide copolymers, (4) fatty acid-modified compounds of phosphates, sorbitan, glycerol, polyethylene glycol, sulfosuccinic acids, sulfonic acids or alkylamines, (5) polyoxyalkylene-modified compounds of sorbitan esters, fatty acid amines, alkanolamides, castor oil, fatty acids, fatty alcohols, (6) quaternary alcohol sulfate compounds, (7) fatty acid imidazolines, (8) polyether-modified trisiloxanes and (9) mixtures thereof.

Specific examples of water- or alcohol-soluble desizing agents of the abovementioned classes of substances are, for example, (1) poly(oxyalkylene) modifications of (a) sorbitan esters (e.g. Alkamuls PSML-4 (poly(oxyethylene) sorbitan monolaurate), Alkamuls PSMO-20 (poly(oxyethylene) sorbitan monooleate), Alkamuls PSTO-20 (poly(oxyethylene) sorbitan trioleate), Alkaril Chemicals); (b) fatty amines (e.g. Alkaminox T-2, T-6 (tallow aminoxyethylate), Alkaminox SO-5 (soybean aminoxyethylate), Alkaril Chemicals), (Icomeen T-2, Icomeen T-15, ICI Chemicals); (c) castor oil (e.g. Alkasurf CO-10, Alkasurf CO-25B (castor oil oxyethylate), Alkaril Chemicals); (d) alkanolamides (e.g. Alkamid C-2, C-5 (coconut oil alkanolamide oxyethylate), Alkaril Chemicals); (e) fatty acids (e.g. Alkasurf 075-9, Alkasurf 0-10, Alkasurf 0-14 (oleic acid oxyethylate), Alkasurf L-14 (lauric acid oxyethylate), Alkasurf P-7 (palmitic acid oxyethylate), Alkaril Chemicals); (b)fatty acid alcohol (e.g. Alkasurf LAN-1, LAN-3, Alkasurf TDA-6, Alkasurf SA-2 (linear alcohol oxyethylate), Alkasurf NP-1, NP-11, Rexol 130 (nonylphenol oxyethylate), Alkasurf OP-1, OP-12 (octylphenol oxyethylate), Alkasurf LA-EP-15, Alkasurf LA-EP-25, Alkasurf LA-EP-65 (linear alcohol oxyalkylate)); (2) hydrophilic poly(dimethylsiloxanes), such as, for example, (a) poly(dimethylsiloxane) having a monocarbinol terminal group (PS556, Petrarch Systems Inc.) and poly(dimethylsiloxane) having a dicarbinol terminal group (PS555, PS556, Petrarch Systems Inc.); (b) poly(dimethylsiloxane)-b-poly(methylsiloxane/alkylene oxide) copolymers (PS 073, PS 072, PS 071, Petrarch Systems Inc.), Alkasil HEP 182-280, Alkasil HEP 148-330 (Alkaril Chemicals), nonhydrolyzable copolymers containing Si—C bonds; (c) poly(dimethylsiloxane)-b-poly(propylene oxide)-b-poly(ethylene oxide) copolymers (Alkasil NEP 73-70, Akaril Chemicals), a hydrolyzable copolymer, containing Si—O—C bonds; (d) polyquaternized poly(dimethylsiloxane) copolymers (which can be obtained from an addition reaction of an α,ω-hydrogen polysiloxane with epoxides containing olefinic bonds and subsequent reaction with a diamine); (3) fatty imidazolines and their derivatives, such as, for example, (a) Alkazin-O(oleyl derivatives); (b) Alkazin TO (tall oil derivative); (c) Alkatric 2C1B (dicarboxylic acid coconut imidazoline sodium salt), Alkaril Chemicals; (d) Arzoline-4; (e) Arzoline-215, Baker Chemicals; (4) fatty acid esters of (a) phosphates (e.g. Alkaphos B6-56A, Alkaril Chemicals); (b) sorbitan (e.g. Alkamuls STO (sorbitan trioleate)), Alkamuls SML (sorbitan monolaurate), Alkamuls SMO (sorbitan monooleate), Alkaril Chemicals); (c) glyceryl compounds (e.g. Alkamuls GMO-45LG (glyceryl monooleate), Alkamuls GDO (glyceryl dioleate), Alkamuls GTO (glyceryl trioleate)); (d) poly(ethylene glycols) (Alkamuls 600 DO (dioleate), Alkamuls 400-ML (monolaurate), Alkamuls 600 MO (monooleate), Alkamuls 600 DL (dilaurate), Alkamuls 600 DT (ditallow), Alkaril Chemicals); (e) sulfosuccinic acid (e.g. Alkasurf SS-O-75 (sodium dioctylsulfosuccinate), Alkasurf SS-DA4-HE (oxyethylate alcohol sulfosuccinate), Alkasurf SS-L7DE (sodium sulfosuccinate ester of lauric acid diethanolamide), Alkasurf SS-L-HE (sodium laurylsulfosuccinate), Alkaril Chemicals); (f) sulfonic acid (e.g. Alkasurf CA (calcium dodecylbenzenesulfonate), Alkasurf IPAM (isopropylamine dodecylbenzenesulfonate), Alkaril Chemicals); (g) alkylamines (e.g. Alkamid SDO (soybean diethanolamide), Alkamid CDE (coconut diethanolamide), Alkamid 2104 (coconut fatty acid diethanolamide), Alkamid CMA (coconut monoethanolamide), Alkamid L9DE (lauryldiethanolamide), Alkamid L7Me (laurylmonoethanolamide), Alkamid L1PA (laurylmonoisopropylamide), Alkaril Chemicals); (5) quaternary compounds, such as, for example, (a) nonpolymeric quaternized ammonium thiosulfate (e.g. Finquat CT, Cordex T-172, Finetex Corporation); (b) quaternary dialkyldimethyl methosulfate (e.g. Alkaquat DHTS (hydrogenated tallow)); (c) alkoxylated quaternized di-fatty methosulfate (e.g. Alkasurf DAET (tallow derivative)); (d) quaternized fatty imidazoline methosulfate (e.g. Alkaquat T (tallow derivatives), Alkaril Chemicals); (6) water-soluble copolymers of lipophilic poly(propylene oxide) with hydrophilic poly(ethylene oxide), such as, for example, (a) methanol-soluble Tetronic 150OR1, Pluronic L-101, Tetronic 902, Tetronic 25R2 (BASF Corporation), Alkatronic EGE-1 (Alkaril Chemicals); (b) water-soluble Tetronic 908, 50R8, 25R8, 904, 90R4, Pluronic F-77, all from BASF Corporation and Alkatronic EGE 25-2 and PGP 33-8 from Alkaril Chemicals; (7) poly(alkylene glycol) and its derivatives, such as, for example, (a) polypropylene glycol (Alkapol PPG 425, Alkapol PPG-4000, Alkaril Chemicals); (b) poly(propylene glycol dimethacrylate), poly(ethylene glycol diacrylate), poly(ethylene glycol dimethacrylate), poly(ethylene glycol monomethyl ether), poly(ethylene glycol dimethyl ether), poly(ethylene glycol diglycidyl ether) (all from Polysciences); (c) poly(1,4-oxybutylene glycol) (Scientific Polymer Products) and the like.

Preferred desizing agents comprise linear alcohol oxyethylates (e.g. Alkasurf LA-EP-65, LA-EP-25 and LA-EP-15, available from Alkaril Chemicals), nonylphenol oxyethylates (e.g. Alkasurf NP-11, available from Alkaril Chemicals, and Rexol 130, available from Hart Chemicals), octylphenol oxyethylates (e.g. Alkasurf OP-12, available from Alkaril Chemicals), oleic acid oxyethylates (e.g. Alkasurf 0-14, available from Alkaril Chemicals), poly(dimethylsiloxane)-b-poly(propylene oxide)-b-poly(ethylene oxide) copolymers (e.g. Alkasil NEP 73-70, available from Alkaril Chemicals), castor oil oxyethylates (e.g. Alkasurf CO25B, available from Alkaril Chemicals), coconut imidazoline dicarboxylic acid sodium salts (e.g. Alkatric 2C1B, available from Alkaril Chemicals) and coconut fatty acid diethanolamides (e.g. Alkamid S104, available from Alkaril Chemicals). The Alkasurf desizing agents are preferably biodegradable.

Suitable surfactants having hydrophobing properties are, for example, sizers such as, for example, alkylsuccinic anhydride (ASA), alkylketene dimer (AKD) and polyolefins (e.g. SÜDRANOL 200, Süddeutsche Emulsions-Chemie GmbH, Mannheim, Germany), waxes, wax-like substances, metal soaps (stearates), paraffin and paraffin emulsions, fatty acids, fatty acid (methyl) ester, fatty alcohols, fatty alcohol polyglycol ether and sulfates thereof.

During the application to the paper, the surfactants may be present in the form of solutions, emulsions or dispersions, which furthermore may contain soluble dyes, as stated further below, and/or further auxiliaries in addition to the surfactants. Conventional auxiliaries are thickeners, such as, for example, gum arabic, polyacrylates, polymethacrylates, polyvinyl alcohols, hydroxypropyl cellulose, hydroxyethyl cellulose, polyvinylpyrrolidone, polyvinyl ether, starch, polysaccharides and the like, optical brighteners, brightness quenchers, pigments (coloring or noncoloring pigments, including pigments having a metallic effect or metals), binders, preservatives and security chemicals, such as, for example, fluorescent, phosphorescent or luminescent compounds. The surfactants are preferably aqueous or alcoholic solutions.

The preparation in step b) preferably contains no binder.

The concentration range of the surfactants in the solutions, emulsions or dispersions which are applied is 0.01 to 30 percent by weight, preferably 0.1 to 25 percent by weight, more preferably in the range from 0.2 to 15 percent by weight.

The ratio of interference pigment to surfactant in the applied solution, emulsion or dispersion is 1:0.08 to 1:0.9, preferably 1:0.09 to 1:0.5, more preferably 1:0.1 to 1:0.4, based on the content of the solid fractions (dry).

In a more preferred embodiment, at least one further pigment (filler) is present in the preparation in step b).

Preferably, the further pigment in step b) is selected from oxides of metals or semimetals, such as, for example, magnesium, calcium, aluminum, zinc, chromium, iron, copper, tin, lead or manganese or diatomite or organic materials or combinations thereof.

Preferably, the further pigment is selected from silicic acid, gibbsite, bayerite, nordostrandite, boehmite, pseudoboehmite, diaspore, aluminum oxide, in particular corundum, hydrated alumina, magnesium silicate, basic magnesium carbonate, titanium (di)oxide, zinc oxide, aluminum silicate, calcium carbonate, talc, kaolin, hydrotalcite, diatomite, organic materials, such as, for example, resin-containing pigments prepared from urea-formaldehyde resins, ethylene resins, styrene resins, acrylate resins or combinations thereof.

The further pigment, present in the preparation in step b), preferably has a large surface area. However, the particles themselves preferably have, as always, a diameter in the range from 1 to 500 nm, preferably from 10 to 100 nm.

The addition of filler to the solution, emulsion or dispersion with which the latent image or pattern is produced has the effect of improving the printing and inscribing properties on the area of the paper which was treated with the surfactant. As a result of the treatment of the paper with a surfactant, a subsequently applied ink is dispersed in the area which is treated (bleeding, feathering). This effect is reduced by the simultaneous application of the surfactant and of a filler since less surfactant is thus required in order to obtain a comparable image or pattern if at the same time the filler is applied. Owing to the smaller proportion of surfactant(s), less dispersing of the printing or inscribing ink is observed. The ratio of filler to surfactant in the applied solution, emulsion or dispersion is 1:0.08 to 1:0.9, preferably 1:0.09 to 1:0.5, more preferably 1:0.1 to 1:0.4, based on the content of the solid fractions (dry).

The applied further fillers (further pigments) are preferably not colored, more preferably transparent, and have a diameter which is so small that no reflection or light dispersion is achieved. The preferred mean diameter of the particles is less than 0.1 μm. The pigments therefore form a colloidal solution in the aqueous system.

Cationic fillers are particularly preferred, which means that the pigments carry a positive charge on their surface. Those that carry a negative charge on their surface, such as, for example, silica, can also be used if the surface is treated so that the negative charge on the surface is changed into a positive one. The positive charge on the cationic surface results in improved bonding of the negatively charged dyes of the subsequent dyeing bath. In this preferred embodiment, nonionic surfactants are used as a mixture with cationic fillers.

The concentration of thickeners which can be used as surfactant auxiliaries is in the range from 0 to 5 percent by weight, preferably 0.01 to 2.5 percent by weight, particularly preferably 0.05 to 2.5 percent by weight, based on the total solution, emulsion or dispersion.

It is more preferable that synthetic colloid-based phyllosilicates can also be used as thickeners in the preparation in step b). These phyllosilicates are preferably lamellar and the surface of the phyllosilicate preferably has a charge differing from that of the edge of the phyllosilicate. Preferably, these thickeners are gel-forming thickeners or sol-forming thickeners. These thickeners preferably lead to a thixotropic preparation which can advantageously be applied to the substrate. Phyllosilicates which are marketed under the trade name “Laponite” may be mentioned by way of example for this class of thickeners.

In order to achieve further special effects on the treated substrate, desizing surfactants and surfactants having hydrophobing properties can also be applied to the same side of the same paper surface.

Any desired dye solution can be used for the formation of the visible image or pattern. An aqueous solution of substantive, basic or acidic dyes or a mixture of these dyes is preferably used. Examples of suitable dye solutions are customary printing inks which contain, for example, anthraquinone, monoazo, diazo, phthalocyanine, aza-(18)-annulene and formazine-copper complex dyes. Examples of suitable dyes are also those which are mentioned further below for the dye solution of the immersion bath, including dyes containing or based on the pigments which are stated further below.

The concentration ranges of the dyes are 0.1 to 30 percent by weight, more preferably 1.0 to 20 percent by weight, particularly preferably 2.0 to 10 percent by weight.

The latent or visible image or pattern can be applied to one side or to both sides of the substrate, so that the finished substrate has, on at least one side, a dyeing which is more or less intense than in the untreated regions of the substrate surface(s).

In a more preferred embodiment, after application of the preparation in step b), the substrate is colored and/or imprinted in a further step c). For the coloring/imprinting, an aqueous dye solution can preferably be used in step c).

The optional imprinting in step c) can be effected with the aid of suitable printing methods, such as, for example, inkjet printing, offset printing, flexographic printing or gravure printing, or by imprinting with the aid of felt or plastic rolls. Here, printing inks and in particular offset printing inks, which contain pigments and printing oils, can be used. It is also possible for the printing inks to contain further security features, such as, for example, special security pigments, which may also be interference pigments. In particular, the interference pigments described further above and present in the preparation can also be present in the printing inks. The printing inks may also be solvent-containing and/or mineral oil-containing.

After the application of the latent or visible image or pattern to the substrate, the substrate can be colored uniformly in step c) with the aid of a dye solution and/or printing ink. This coloring is carried out in such a way that the total area is covered, either inside or outside the paper machine, by the application of dye solution(s) and/or printing ink/printing inks, which are preferably solvent-containing and/or mineral oil-containing, to the substrate by means of classical paper coating units and methods, such as, for example, a size press, film press, knife coater, bath coater, rollers or spraying on or by the application of a dye solution and/or printing ink to the total surface of the substrate with the aid of suitable printing methods, such as, for example, inkjet printing, offset printing, flexographic printing, gravure printing, or by imprinting with the aid of felt or plastic rolls, by spraying on or by coloring the paper by immersion in a dye bath. Preferably, the color is applied in an immersion method from an aqueous dye solution.

Any commercially available dye solution can be used for the purposes of the present invention. The dye solution usually contains dyes in a concentration range from 0.1 to 50 percent by weight, preferably up to 35 percent by weight, particularly preferably 0.1 to 30 percent by weight. The concentration of the dye solution can be adjusted to correspond to the individually desired effect to be achieved (intensity of the subsequently desired image). Comparative examples can be carried out by any person skilled in the art by simple testing.

In the immersion process, the substrate is immersed in an aqueous dye solution after application of the latent image or visible image or pattern and subsequently pressed and dried. Immersion dyeing can be carried out with the use of sized or unsized substrate webs or substrate sheets. By means of immersion dyeing, it is possible to achieve very rich colors of very high luminosity. A further advantage of this method is that even small amounts can be colored without an ineffective process.

If the latent image was applied before the coloring of the substrate, the substrate absorbs the color during the dyeing process to a greater or lesser extent than in the untreated areas, this depending on the substance with which the substrate was pretreated.

A greater acceptance of inks in areas which were pretreated with a desizing agent leads to a substrate in which the image or pattern which was applied in latent form appears in a higher color saturation of the same color compared with the remaining substrate which was colored. The color intensity of the image or pattern therefore subsequently appears “positive” and can be varied by the applied proportion and/or composition of the desizing bath.

If a water repellent was applied before the coloring of the paper, the image or pattern initially applied in latent form appears with a less intense color after dyeing of the substrate compared with the same color in the total paper. Here too, the color intensity of the image or pattern can subsequently be varied as “negative” by the variation of the applied amount and/or composition of the applied water repellent.

For the formation of the latent image, it is also possible to apply a desizing agent and hydrophobic substances side by side on the same substrate surface so that the finished substrate has both “positive” and “negative” images or patterns.

In order to obtain the effects described above, it is necessary for the coloring of the substrate to be effected after the application of substances which influence the ink absorption.

If a visible image or pattern is applied before the coloring of the substrate, the subsequent coloring of the substrate intensifies the previously applied image or pattern so that a special effect, namely a nonuniformly intense coloring on the substrate, can also be achieved. This effect is achieved only if the substrate which carries the visible image is additionally colored.

Customary aqueous dye solutions can be used for coloring the substrate. These may contain basic and/or acidic and/or substantive dyes. Examples of suitable dye solutions are solutions which contain anthraquinone, monoazo, diazo, phthalocyanine, aza-(18)-annulene and formazan-copper complex dyes. Specific examples of suitable dyes are mentioned in EP-A 559 324, on page 4, lines 25 to 53. These are in particular triphenodioxazines, Bernacid Red 2BMN; Pontamine Brilliant Bond Blue A; Pontamine; Food Black 2; Carodirect Turquoise FBL Supra Conc. (Direct Blue 199), available from Carolina Color and Chemical; Special Fast Turquoise 8GL Liquid (Direct Blue 86), available from Mobay Chemical; Intrabond Liquid Turquoise GLL (Direct Blue 86), available from Crompton and Knowles; Cibracron Brilliant Red 38-A (Reactive Red 4), available from Aldrich Chemical; Drimarene Brilliant Red X-2B (Reactive Red 56), available from Pylam, Inc.; Levafix Brilliant Red E-4B, available from Mobay Chemical; Levafix Brilliant Red E-6BA, available from Mobay Chemical; Procion Red H8B (Reactive Red 31), available from ICI America; Pylam Certified D & C Red #28 (Acid Red 92), available from Pylam; Direct Brill Pink B Ground Crude, available from Crompton & Knowles; Cartasol Yellow GTF, available from Sandoz, Inc.; Tartrazine Extra Conc. (FD & C Yellow #5, Acid Yellow 23), available from Sandoz; Carodirect Yellow RL, (Direct Yellow 86), available from Carolina Color and Chemical; Cartasol Yellow GTF Liquid Special 110, available from Sandoz, Inc.; D & C Yellow #10 (Acid Yellow 3), available from Tricon; Yellow Shade 16948, available from Tricon, Basacid Black X34, available from BASF, Carta Black 2GT, available from Sundoz, Inc.; Direct Brilliant Pink B (Crompton-Knolls); Kayanol Red 3BL (Nippon Kayaku Company); Levanol Brilliant Red 3BW (Mobay Chemical Company); Levaderm Lemon Yellow (Mobay Chemical Company); Spirit Fast Yellow 3G; Sirius Supra Yellow GD 167; Cartasol Brilliant Yellow 4GF (Sandoz); Pergasol Yellow CGP (Ciba-Geigy); Dermacarbon 2GT (Sandoz); Pyrazole Black BG (ICI); Morfast Black Conc A (Morton-Thiokol); Diazole Black RN Quad (ICI); Luxol Blue MBSN (Morton-Thiokol); Sevron Blue 5GMF (ICI); Basacid Blue 750 (BASF); Bernacid Red, available from Berncolors, Poughkeepsie, N.Y.; Pontamine Brilliant Bond Blue; Berncolor A.Y. 34; Telon Fast Yellow 4GL-175; BASF Basacid Black SE 0228; the Pro-Jet series available from ICI, including Pro-Jet Gelb I (Direct Yellow 86), Pro-Jet Magenta I (Acid Red 249), Pro-Jet Cyan I (Direct Blue 199), Pro-Jet Black I (Direct Black 168), Pro-Jet Yellow 1-G (Direct Yellow 132), Aminyl Brilliant Red F-B, available from Sumitomo Chemical Co. (Japan), the Duasyn Linievon “salt-free” dyes, available from Hoechst, such as, for example Duasyn Direct Black HEF-SF (Direct Black 168), Duasyn Black RL-SF (Reactive Black 31), Duasyn Direct Yellow 6G-SF VP216 (Direct Yellow 157), Duasyn Brilliant Yellow GL-SF VP220 (Reactive Yellow 37), Duasyn Acid Yellow XX-SF VP413 (Acid Yellow 23), Duasyn Brilliant Red F3B-SF VP218 (Reactive Red 180), Duasyn Rhodamine B-SF VP353 (Acid Red 52), Duasyn Direct Turquoise Blue FRL-SF VP368 (Direct Blue 199), Duasyn Acid Blue AE-SF VP344 (Acid Blue 9), and the like and mixtures of these dyes.

Further dyes which can be used contain or are based on pigments (coloring or noncoloring pigments).

The concentration of the dyes depends on the manufacturer and also on the dye used and is not limiting for the present invention.

The dye solutions may also contain further additives, such as, for example, alcohol, thickeners, wet strength agents, optical brighteners, preservatives, security chemicals, binders and pigments (coloring or noncoloring pigments, such as, for example, calcium carbonate). Auxiliaries for the dye solution are in particular gum arabic, polyacrylate salts, polymethacrylate salts, polyvinyl alcohols, hydroxypropylcellulose, hydroxyethylcellulose, polyvinylpyrrolidones, polyvinyl ether, starch, polysaccharides and the like. Further customary additives for inks may also be present. Such customary additives are disclosed in EP-A-518 490, page 4, line 55 to page 5, line 9.

The present invention furthermore relates to a substrate obtainable by the abovementioned method.

Surprisingly, the amount of interference pigment which is necessary to achieve an effect can be reduced by a factor of 10 in comparison with the application of interference pigments by means of printing inks. In particular, it is found that, if interference pigments are applied in a low concentration, they are initially not visible to the unaided eye on the substrate but are visible after development with a dye solution or printing ink. It is therefore possible in an advantageous manner to provide substrates with security features which initially appear to an observer as if no security feature is applied but show the security feature by a simple procedure, namely by applying dye solutions and/or printing inks. Surprisingly, it is therefore possible to provide substrates with security features in which an inexpert observer does not immediately find the security feature and therefore believes that the substrate has no security feature. By the simple development with a dye solution and/or printing ink, however, it is possible in a very simple manner to check whether a substrate with a security feature is present or not. Forgeries can thus be recognized in a very simple manner.

If the substrate was colored and/or imprinted in the optional step c), the interference pigments are subsequently very easily visible. The contrast between areas which have interference pigments and those which were not treated is very great. This is very surprising since the applied amount of interference pigment is very much smaller compared with a printing ink which contains such pigments. In spite of the smaller applied amount, the interference pigment is just as visible in the case of a substrate according to the invention after coloring or imprinting as if said pigment had been applied by means of a printing ink. Owing to the special structure of the substrate according to the invention, however, it is impossible for a counterfeiter to forge such a substrate.

However, it is also possible for the applied interference pigment to be colored and/or imprinted only in certain areas of the substrate so that areas in which the interference pigment is not visible to the unaided eye are also present. On checking such a substrate for forgeries, it is therefore necessary only to color and/or imprint the still uncolored areas in order to make the interference pigment visible. Such a check can be effected, for example, by means of a felt pen and is therefore very simple to carry out.

The subject matter of the present invention is explained below in detail on the basis of examples.

### EXAMPLES

A paper having a basis weight of 105 g/m² is produced on a Fourdrinier machine. The pulp composition contains 80 percent by weight of long-fiber sulfate pulp and 20 percent by weight of eucalyptus sulfate pulp. The sizing of the paper is carried out with the use of rosin size and alum. 1 percent of a urea-formaldehyde resin is used as a wet strength agent. The paper according to the examples has no surface sizing.

### Example 1

An aqueous solution containing 80.4 g of water, 5.0 g of the interference pigment “colorstream T10-01 Fantasy”, available from Merck, 4.40 g of modified starch, 1.0 g of a water repellent and 4.0 g of an antifoam is prepared. A polyether-modified trisiloxane (nonionic surfactant) from Goldschmidt having the trade name TEGOPREN 5847 is used as a surfactant. 0.2 g of the surfactant TEGOPREN 5847 (commercial product) is introduced. In addition, the aqueous preparation contains, as a thickener, 7.0 g of a phyllosilicate, which is sold under the trade name “Laponite RDS”.

### Example 2

An aqueous solution containing 79.30 g of water, 1.50 g of the interference pigment “Iriodin 123”, available from Merck, 4.0 g of modified starch, 3.00 g of a particulate silica, 1.50 g of a water repellent and 3.50 g of an antifoam is prepared. A polyether-modified trisiloxane (nonionic surfactant) from Goldschmidt having the trade name TEGOPREN 5847 is used as a surfactant. 0.2 g of the surfactant TEGOPREN 5847 (commercial product) is introduced. In addition, the aqueous preparation contains, as a thickener, 7.0 g of a phyllosilicate, which is sold under the trade name “Laponite RDS”.

The aqueous preparations according to examples 1 and 2 are applied to the abovementioned paper with the aid of a coating unit, such as, for example, a Fineliner (Rotring Rapidograph, 0.35 mm diameter), a tension spring or a brush and by means of a flexographic printing unit.

After drying of the paper, papers which are provided with a preparation and do not show the applied patterns and letters in visible form are obtained.

If the papers prepared in this manner are subsequently immersed in a dye solution, such as, for example, a 1.0% strength by weight aqueous Cartasol Blue 3 RF solution (Sandoz Chemikalien AG, Basel/Clariant Deutschland GmbH, Lörrach), the applied letters are very clearly visible and appear positive. Here, the effect of the interference pigments is very clearly visible even though only a very small amount of interference pigment was applied in comparison with a paper imprinted with interference pigments.

1. Method for applying interference pigments to a substrate, comprising the steps:
a) providing a substrate, and
b) applying a preparation to at least one side of the substrate, where the preparation comprises at least one surfactant and at least one interference pigment, the interference pigment comprising a carrier material and at least one coat applied to the carrier material,
wherein the preparation in step b) contains no binder.

2. Method according to claim 1, wherein the substrate in step a) is a paper and/or cardboard.

3. Method according to claim 1, wherein the preparation in step b) is applied in the form of a latent image or pattern.

4. Method according to claim 1, wherein the application of the preparation is effected by inkjet printing, offset printing, flexographic printing, gravure printing or imprinting with the aid of felt or rubber rollers, by spraying on or manually.

5. Method according claim 1, wherein the carrier material of the interference pigment has a lamellar structure and/or is an inorganic carrier material.

6. Method according to claim 1, wherein the carrier material of the interference pigment in step b) contains natural or synthetic mica, talc, kaolin, glass lamellae, SiO₂ lamellae, TiO₂ lamellae, Al₂O₃ lamellae, Fe₂O₃ lamellae, graphite lamellae or mixtures thereof.

7. Method according to claim 1, wherein two, three, four or five coats, which can each be identical or different, are applied to the carrier material of the interference pigment in step b).

8. Method according to claim 1, wherein the at least one coat of the at least one interference pigment in step b) contains, independently of one another, oxides of metals or semimetals or mixtures thereof.

9. Method according to claim 1, wherein the at least one coat of the at least one interference pigment in step b) contains an oxide selected from the group consisting of TiO₂, titanium suboxide, titanium oxide nitride, Fe₂O₃, Fe₃O₄, SnO₂, Sb₂O₃, SiO₂, Al₂O₃, ZrO₂, B₂O₃, Cr₂O₃, ZnO, CuO, NiO and mixtures thereof.

10. Method according to claim 1, wherein the interference pigment in step b) has a mean particle size of 1 μm to 500 μm.

11. Method according to claim 1, wherein the surfactant in step b) reduces the penetration of water-soluble dyes into the substrate.

12. Method according to claim 1, characterized in that the surfactant in step b) facilitates the penetration of water-soluble dyes into the substrate.

13. Method according to claim 1, wherein both a surfactant which facilitates the penetration of water-soluble dyes into the paper and a surfactant which reduces the penetration of water-soluble dyes into the paper are applied in step b).

14. Method according to claim 1, wherein the application in step b) is effected on a continuous paper web.

15. Method according to claim 1, wherein at least one further pigment is present in the preparation in step b).

16. Method according to claim 15, wherein the further pigment in step b) is selected from the group consisting of oxides of metals, semimetals diatomite materials, organic materials and combinations thereof.

17. Method according to claim 15, wherein the further pigment is selected from the group consisting of silicic acid, gibbsite, bayerite, nordostrandite, boehmite, pseudoboehmite, diaspore, aluminium oxide, in particular corundum, hydrated alumina, magnesium silicate, basic magnesium carbonate, titanium (di)oxide, zinc oxide, aluminum silicate, calcium carbonate, talc, kaolin, hydrotalcite, diatomite and organic materials.

18. Method according to claim 1, wherein, after application of the preparation in step b), the substrate is colored and/or imprinted in a further step c).

19. Method according to claim 18, wherein an aqueous dye solution is used for the coloring/imprinting in step c).

20. Method according to claim 18, wherein the coloring/imprinting in step c) is effected inside or outside a paper machine by application of a dye solution/dye solutions and/or printing ink/printing inks, which are preferably solvent-containing and/or mineral oil-containing, to the substrate by means of a classical paper coating apparatus and/or by a method selected from the group consisting of a size press, a film press, a knifecoating unit, blades, rollers, spraying on, application of a dye solution and printing ink to the total surface of the paper with the aid of suitable printing methods.

21. Method according to claim 3, wherein the image or pattern has a diagram, a symbol, a uniform or nonuniform pattern, a network structure or any desired nonuniform color distribution.

22. Substrate obtainable by the method according to claim 1.

23. The method of claim 8, wherein the semimetals are selected from the group consisting of Si, Sn, Ti and Fe.

24. The method of claim 16, wherein the oxides of metals or semimetals are selected from the group consisting of magnesium, calcium, aluminum, zinc, chromium, iron, copper, tin, lead and manganese.

25. The method of claim 17, wherein the organic materials are resin-containing pigments prepared from urea-formaldehyde resins, ethylene resins, styrene resins, acrylate resins or combinations thereof.

26. The method of claim 20, wherein said suitable printing methods are selected from the group consisting of inkjet printing, offset printing, flexographic printing, gravure printing, imprinting by means of felt or rubber rollers, spraying on and immersion dyeing.
